(19) United States
(12) Patent Application Publication
(10) Pub. No.: US 2005/0177747 A1
(43) Pub. Date: Aug. 11, 2005

(54) Document transporter

(76) Inventor: Roger Scott Twede, Meridian, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/773,974

(22) Filed: Feb. 6, 2004

(51) Int. Cl. H04L 9/00

(52) U.S. Cl. 713/201

(57) ABSTRACT

Transporting a document includes notarizing an original document, encrypting the document and electronically transmitting the original document from the first imaging device to a second imaging device. An image of the original document is electronically receiving at the second imaging device, decrypted and certified. The original document at the first imaging device is destroyed.

### BACKGROUND OF THE INVENTION

Many business transactions end in a formal closing in which there are a multitude of documents that must be signed and notarized in order to consummate the transaction. In many instances, one of the parties signing documents may be in at a different location than another party. One common instance where a party is remotely located from another party is a house closing. Many times the lender or mortgagor is in another city from the borrower or the mortgagee. The lender generally has to sign many papers that must be sent via overnight courier to the mortgagor before the mortgage transaction is complete. In many instances, mistakes are made and additional signed papers are required. In the event of a mistake, the mortgagee or mortgagees must reassemble, sign the necessary document, and resend the document to the mortgagee. In any event, the closing may be delayed for several days. This can delay paying off previous notes and throw off the amount of funds needed at closing. Of course, a similar scenario occurs in a business transaction where large sums of money are at stake and deals may hinge on meeting particular deadlines.

### BRIEF DESCRIPTION OF THE DRAWINGS

FIG. 1 is a schematic diagram of a document transport system, according to an embodiment of this invention.

FIG. 2 is a schematic side view of a multi-functional imaging apparatus, according to an embodiment of this invention.

FIG. 3 is a functional block diagram of the embodiment shown in FIG. 2, according to an embodiment of this invention.

FIG. 4 is a schematic diagram of an electronic device that includes a computer system, according to an embodiment of this invention.

FIG. 5 is a schematic side view of a multi-functional imaging apparatus, according to another embodiment of this invention.

FIG. 6 is a flow chart of a method for transporting a document, according to an embodiment of this invention.

FIG. 7 is a flow chart of another method for transporting a document, according to an embodiment of this invention.

FIG. 8 is a flow chart of a security process, according to an embodiment of this invention.

FIG. 9 is a block diagram of a computer readable medium that includes an instruction set, according to an embodiment of this invention.

### DETAILED DESCRIPTION

In the following description and the drawings illustrate specific embodiments of the invention sufficiently to enable those skilled in the art to practice it. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. The scope of the invention encompasses the full ambit of the claims and all available equivalents. The following description is, therefore, not to be taken in a limited sense, and the scope of the present invention is defined by the appended claims.

The functions described herein are implemented in software in one embodiment, where the software comprises computer executable instructions stored on computer readable media such as memory or other type of storage devices. The term “computer readable media” is also used to represent carrier waves on which the software is transmitted. Further, such functions correspond to modules, which are software, hardware, firmware of any combination thereof. Multiple functions are performed in one or more modules as desired, and the embodiments described are merely examples.

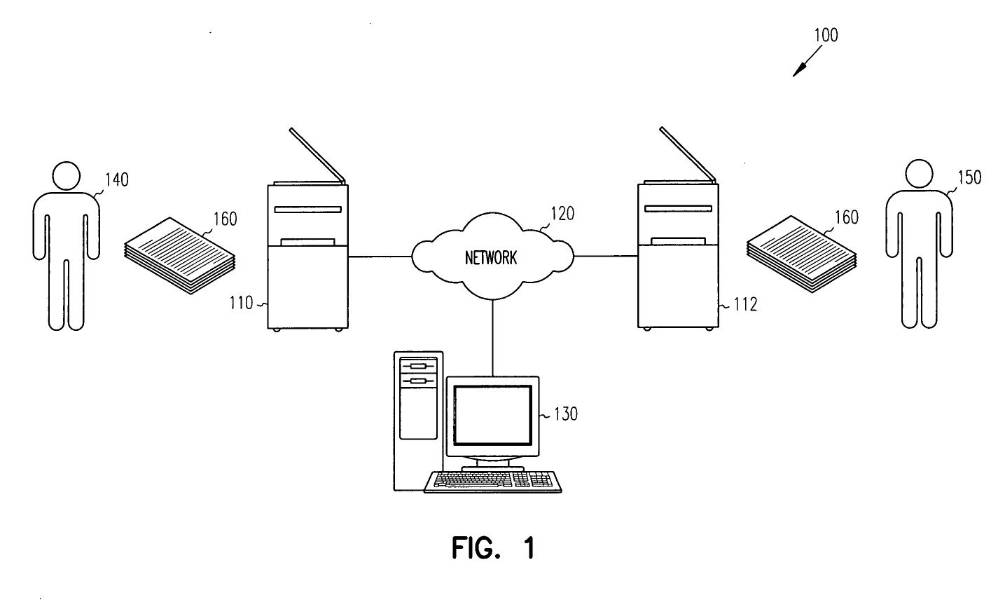

FIG. 1 is a schematic diagram of a document transport system 100, according to an embodiment of this invention. The document transport system 100 includes a first imaging apparatus 110 and a second imaging apparatus 112. The first imaging apparatus 110 and the second imaging apparatus 112 are linked together over a network 120, such as the Internet, a local area network (LAN) or a wide area network (WAN) or the like. The document transport system 100 also includes a notary certification service 130. The notary certification service 130 certifies the identity of an owner 140 or user of a first imaging apparatus 110 as well as certifying that the owner also has certain private information such as a private key in a public key, private key security system. The notary certification service 130 also verifies information regarding the private key or the private information and furthermore associates at least one specific machine or imaging device with a specific owner. For example, as shown in FIG. 1, a person 140, such as a public notary, is associated with owning or using a particular machine such as imaging apparatus 110. A second person 150 is associated with using or owning a second imaging apparatus 112. Of course it should be noted that a specific person 140 or 150 can be certified as being associated with more than one imaging apparatus or other device. This would allow a person 140 having an office or having two separate offices to have more than one machine or imaging apparatus associated with a particular person. Thus, a person 140, such as a public notary, is not tied to a particular device or imaging apparatus, but can use one of several imaging apparatus that are associated with that particular person. For example, while person 140 may having imaging apparatus 110 in a main office, another imaging apparatus in a home office, and yet a further imaging apparatus which is portable so that the person 140 can conduct work and transmit or transport a document 160 over the document transport system 100 to another person 150.

In terms of an overview, legal documents need to be transported and the persons 140, 150 using the document transport system 100 must be assured that the first person or sender 140 placed a document onto the imaging apparatus 110 and that an accurate copy or image is formed by an imaging apparatus 110 and that it is transported to a second imaging apparatus 112 without being altered. As shown in FIG. 1, the persons 140 and 150 are public notary and therefore notarize documents and transport them to other notaries frequently. The process is for the first notary 140 to notarize that a document 160 has been placed on a first imaging apparatus 110. Of course the public notary may also have other notarizing duties including notarizing the fact that certain people signed the document. The document which has been notarized is being placed on imaging apparatus 110 is then transported to imaging apparatus 112 where the second notary 150 receives a copy of the original image and notarizes that it was output from a second imaging apparatus 112.

The notary certification service 130 certifies the identity of the first person 140 and the second person 150 and also certifies or verifies the association of certain machines, such as an imaging device, as owned and used by the first person 140 and the second person 150. The notary certification service 130 maintains a listing of certificates and issues private keys to person 140 and person 150. The notary certification service also posts public keys for person 140 and person 150. Thus, the notary certification service can use a public key/private key security scheme and further include an additional level of security by verifying that the person 140 used a machine or imaging device 110 to which he or she has access. The notary certification service can be called upon to prove later on that the person 140 or 150 sent the device and that another person 140 or 150 received an original copy of the original image and furthermore that each person 140 and 150 used the devices or imaging apparatus to which they had access.

In some embodiments, a time stamp is included with a unique machine identifier. For example, a global universal identification that includes a unique sequence in time and space and the unique media access control (MAC) can also be included with the transmission or transport of the document. The result is that the notary certification service 130 is able to tell the sender of the document, the receiver of the document, the machine on which it was received and the machine on which it was sent, and the exact time of the transaction. The following paragraphs detail the document transport system 100 and the method or methods of using the document transport system 100 to assure that documents are transported between a particular sender and a particular receiver.

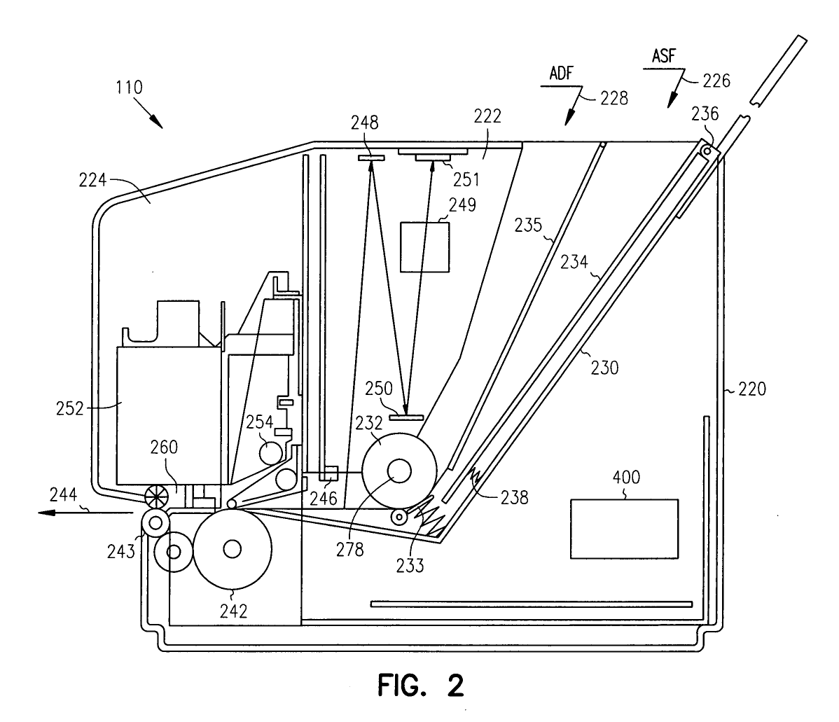

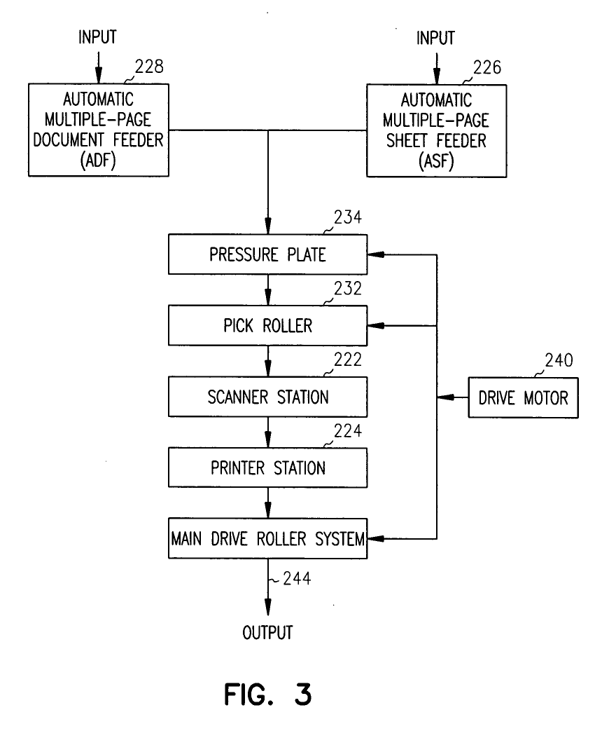

FIG. 2 is a schematic side view of a multi-functional imaging apparatus 110, according to an embodiment of this invention. FIG. 3 is a functional block diagram of the embodiment of the multi-functional imaging apparatus 110 shown in FIG. 2, according to an embodiment of this invention. The multi-functional imaging apparatus 110 shown and described is an example of one type of imaging apparatus that is used as part of the document transport system 100. Of course, the document transport system requires at least two imaging apparatuses. However, only one imaging apparatus will be described below for the sake of brevity and clarity.

Now, referring to both FIGS. 2 and 3, the multiple-function imaging apparatus 110 includes a frame 220 for housing a scanner station 222 and a printer station 224. A stack of print sheets is loadable into an automatic sheet feeder (ASF) 226, and a stack of documents having text/graphics to be scanned is loadable into an automatic document feeder (ADF) 228 which together form a common input feeder slot 230 having a pick roller 232 and a spring-loaded stripper pad 233 at the lower end. The upper portion of the input feeder slot that constitutes the ADF is separated from the ASF by a divider 235. The divider 235 is truncated at the lower end to allow document stacks and sheets stacks to converge at the pick roller 278. A pressure plate 234 is attached at its upper end through pivot pin 236 to the frame and is normally biased upwardly against the pick roller by springs 238. A drive motor 240 is connected through a gear mechanism to the pressure plate 234 and pick roller 232 and is also connected to a main drive roller 242 which pulls the pages through the processing stations (i.e. either the scanning station 222 or printing station 224. The printout pages as well as the scanned pages pass across an output roller 243 to be deposited in a common output area 244.

The scanner station 222 includes a lamp 246 for illuminating a scanning zone, reflective mirrors 248, 250, a lens 249, and a CCD (charge-coupled device) photosensor 251. Printer station 224 includes inkjet cartridge 252 that rides on a slider rod 254 and moves back and forth across a print zone 260. The multi-functional imaging apparatus 110 also includes an electronic device 400 also known as an information handling system. The electronic device 400 or information handling system includes all devices capable of handling information, including but not limited to a dedicated micro-controller, a microprocessor or a computer. The electronic device 400 generally controls the hardware within the multi-function imaging apparatus 110, the tasks of the multi-function imaging apparatus 110, and the communications between the multi-function imaging apparatus 110 and the communications to and from various interfaces to networks 120 (shown in FIG. 1) such as the Internet, local area networks, wide area networks, and the like.

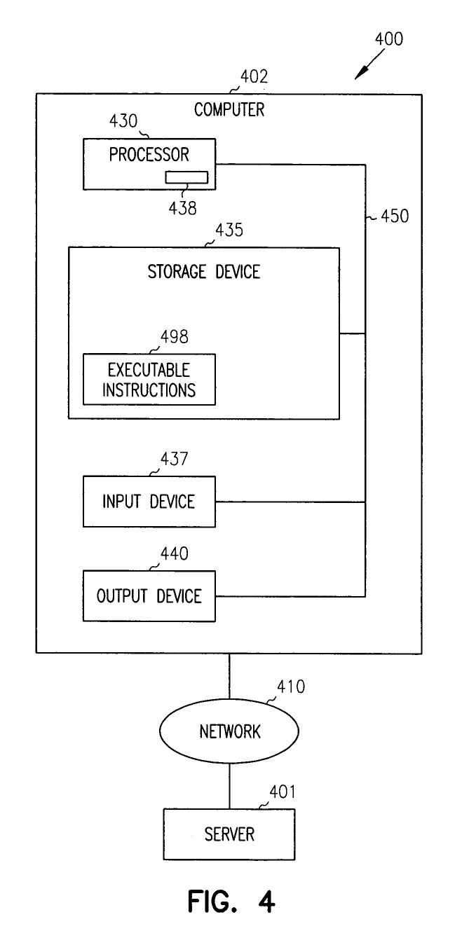

FIG. 4 is a schematic diagram of an electronic device 400. The electronic device 400 includes a computer system 402, according to an embodiment of this invention. The computer system 402 includes a processor 430 and a storage device 435. The storage device 435 includes executable instructions 498. The executable instructions 498 are stored within the storage device 435. The electronic device 400 includes a network 410 and a server 401. The computer 402 is communicatively coupled to the network 410. The network 410 and the computer 402 are communicatively coupled to the server 401.

The processor 430 represents a central processing unit of any type of architecture, such as a CISC (Complex Instruction Set Computing), RISC (Reduced Instruction Set Computing), VLIW (Very Long Instruction Word), or hybrid architecture, although any appropriate processor may be used. The processor 430 executes instructions and includes that portion of the electronic device 400 that controls the operation of the entire electronic device. The processor 430 includes a control unit 438 that organizes data and program storage in memory and transfers data and other information between the various parts of the electronic device 400. The processor 430 receives input data from the input device 437 and the network 410, reads and stores code and data in the storage device 435, and presents data to an output device 440 and/or the network 410.

Although the electronic device 400 is shown to contain only a single processor 430 and a single bus 450, the present invention applies equally to electronic devices that may have multiple processors and multiple buses with some or all performing different functions in different ways.

The storage device 435 represents one or more mechanisms for storing data. For example, the storage device 435 may include read only memory (ROM), random access memory (RAM), magnetic disk storage media, optical storage media, flash memory devices, and/or other machine-readable media. In other embodiments, any appropriate type of storage device may be used. Although only one storage device 435 is shown, multiple storage devices and multiple types of storage devices may be present, and in various embodiments some or all of the product codes, the controller 438, and the products may be stored on the same or on different storage devices. Further, although the electronic device 400 is drawn to contain the storage device 435, it may be distributed across other electronic devices, for example on computers attached to the network 410.

The controller 438 includes instructions capable of being executed on the processor 430 to carry out the functions of the present invention. In another embodiment, some or all of the functions of the present invention are carried out via hardware in lieu of a processor-based system.

The input device 437 may be a keyboard, mouse or other pointing device, trackball, touchpad, touchscreen, keypad, microphone, voice recognition device, or any other appropriate mechanism for the user to input into the electronic device 400. Although one input device 437 is shown, in another embodiment any number (including none) and type of input devices may be present.

The output device 440 is that part of the electronic device 400 that communicates output to the user. The output device 440 may be a cathode-ray tube (CRT) based video display well known in the art of computer hardware. But, in other embodiments the output device 440 may be replaced with a liquid crystal display (LCD) based or gas, plasma-based, flat-panel display. In another embodiment, the output device 440 may be a speaker. In still other embodiments, any appropriate output device may be used. Although one output device 440 is shown, in other embodiments, any number (including none) of output devices of different types or of the same type may be present. In one embodiment, the output device is part of the imaging apparatus 110 (FIG. 1). In another embodiment, the output device is a separate, stand-alone device.

The bus 450 may represent one or more busses, e.g., PCI, ISA (Industry Standard Architecture), X-Bus, EISA (Extended Industry Standard Architecture), or any other appropriate bus and/or bridge (also called a bus controller).

The electronic device 400 may be implemented using any suitable hardware and/or software, such as a personal computer. Portable computers, laptop or notebook computers, PDAs (Personal Digital Assistants), pocket computers, telephones, pagers, appliances, and mainframe computers are examples of other possible configurations of the electronic device 400. The hardware and software depicted in FIG. 4 may vary for specific applications and may include more or fewer elements than those depicted. For example, other peripheral devices such as audio or chip programming devices, such as EPROM (Erasable Programmable Read-Only Memory) programming devices may be used in addition to or in place of the hardware already depicted.

The network 410 may be any suitable network and may support any appropriate protocol suitable for communication between the electronic device 400 and the imaging apparatus 110 or other electronic devices. In an embodiment, the network 410 may support wireless communications. In another embodiment, the network 410 may support hard-wired communications, such as a telephone line or cable. In another embodiment, the network 410 may support the Ethernet IEEE (Institute of Electrical and Electronics Engineers) 802.3x specification. In another embodiment, the network 410 may be the Internet and may support IP (Internet Protocol). In another embodiment, the network 410 may be a local area network (LAN) or a wide area network (WAN). In another embodiment, the network 410 may be a hotspot service provider network. In another embodiment, the network 410 may be an intranet. In another embodiment, the network 410 may be a GPRS (General Packet Radio Service) network. In another embodiment, the network 410 may be any appropriate cellular data network or cell-based radio network technology. In another embodiment, the network 410 may be a wireless network. In still another embodiment, the network 410 may be any suitable network or combination of networks. Although one network 410 is shown, in other embodiments any number of networks (of the same or different types) may be present.

Aspects of an embodiment pertain to specific apparatus and method elements implementable on a computer or other electronic device. In another embodiment, the invention may be implemented as a program product for use with an electronic device. The programs defining the functions of this embodiment may be delivered to an electronic device via a variety of signal-bearing media, which include, but are not limited to:

(1) information permanently stored on a non-rewriteable storage medium, e.g., a read-only memory device attached to or within an electronic device, such as a CD-ROM readable by a CD-ROM drive;

(2) alterable information stored on a rewriteable storage medium, e.g., a hard disk drive or diskette; or

(3) information conveyed to an electronic device by a communications medium, such as through a computer or a telephone network, including wireless communications.

Such signal-bearing media, when carrying machine-readable instructions that direct the functions of the present invention, represent embodiments of the present invention.

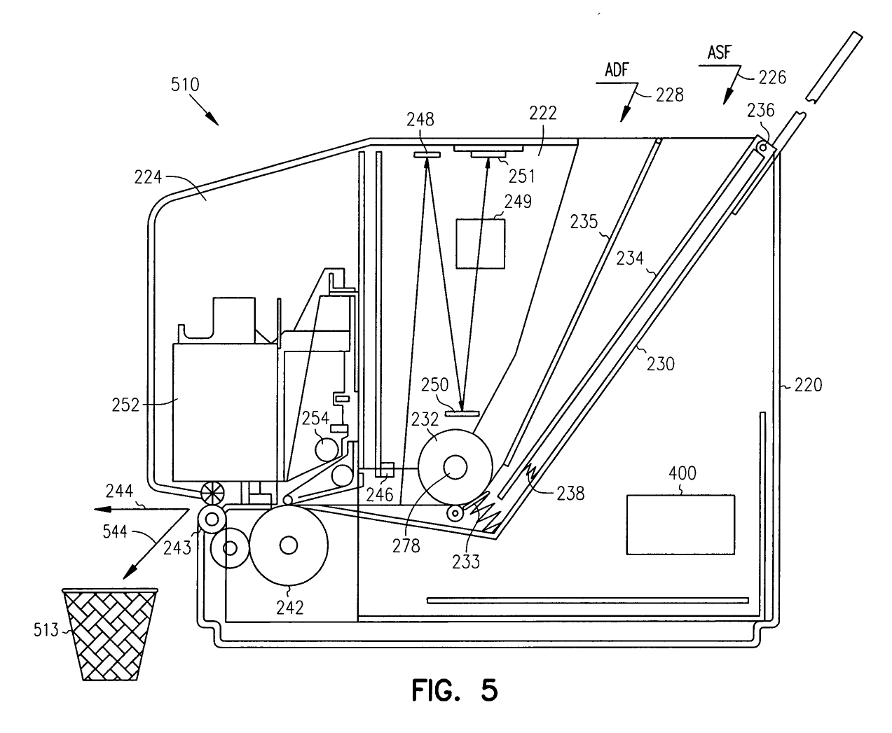

FIG. 5 is a schematic side view of a multifunctional imaging apparatus 510, according to another embodiment of this invention. The multifunction imaging apparatus 510 is very similar to the multi-imaging apparatus 110 shown and described in FIG. 2. As a consequence, only the different elements between imaging apparatus 510 and imaging apparatus 110 will be described here. The imaging apparatus 510 includes a first output path 244 and a second output path 544. The second output path 544 places an original document which has been imagined by the imaging apparatus 510 and sent to a second imaging apparatus such as imaging apparatus 112 (FIG. 1) into a trash can 513. In some embodiments of the invention, once the original document has been imaged and either sent or received by a second imaging apparatus or an intended imaging apparatus, the original document is destroyed which is depicted by the output path 544 and the trash can 513 shown in FIG. 5. The controller 400 controls the mechanism for destroying the original document. In other words, the information handling system within the imaging apparatus 510 directs the output of an original document to output path 544 when a command has been received to image the document and send it to a second imaging apparatus, such as imaging apparatus 112 (shown in FIG. 1). The information handling system or electronic device 400 destroys the document or directs it to an output path for destruction when an indication that the document has been received by the receiving imaging apparatus is received by the imaging apparatus 510 and specifically by the electronic device or information handling system 400. The electronic device or information handling system 400 is capable of receiving a signal indicating that a copy has been output at a second imagine apparatus 112 (shown in FIG. 1) or that an image has been received by the second imaging apparatus 112 (shown in FIG. 1).

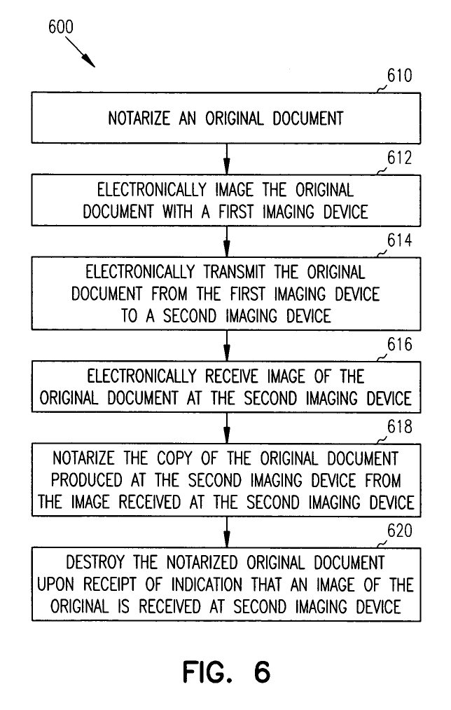

FIG. 6 is a flow chart of a method for transporting a document 600 according to an embodiment of this invention. The method for transporting the document includes notarizing an original document as depicted by reference numeral 610, electronically imaging the original document with a first imaging device, as depicted by reference numeral 612, electronically transmitting the original document from the first imaging device to a second imaging device as depicted by reference numeral 614, electronically receiving an image of the original document at the second imaging device or apparatus, as depicted by reference numeral 616 and notarizing the copy of the original document produced at the second imaging device from the image received at the second imaging device as depicted by reference numeral 618.

Electronically transmitting the original document 614 and receiving the image of the original document at the second imaging device 616 is done in a secure environment and includes encrypting the image of the original document. In one embodiment, the document is encrypted with the sender's private key. The sender's public key can be used by the recipient to open the document. Using the sender's private key assures the recipient of the document that the document came from the sender. In another embodiment, the image is double encrypted. The image is first encrypted using the sender's private key. The image is then encrypted again using a public key of a party to receive the image of the original document. Double encrypting provides the receiver of the document assurances that the image was sent by a sender and the destination of the image at the time of being sent was the receiver. For example, an image is encrypted at the first imaging device 110 (FIG. 1) using the sender's private key and the recipient's public key. When the document is received at the second imaging apparatus 112, the receiver decrypts the image by applying their private key (private key of the recipient), and then using the public key of the sender. In an alternative embodiment, the sequence of encryption can be reversed so that the sender (imaging apparatus 110) double encrypts by initially applying the recipient's public key and then applying the sender's private key to the document. At the receiving end, the sender's public key is initially used and then the private key of the recipient.

Notarizing the copy of an original document 618, in some embodiments, further includes certifying that the original document 160 (FIG. 1) was imaged on an imaging device 110 that encrypts the original document 160 using the private key of the sender 140. In another embodiment of the invention, notarizing the copy of an original document 618 includes certifying that the original document 160 was imaged on an imaging device 110 (shown in FIG. 1) that was double encrypted. The double encryption included using the private key of the sender and the public key of the recipient. In other embodiments, notarizing the copy of an original document 618 produced at the second imaging device 112 from the image received at the second imaging device further includes certifying that the copy of the original document was decrypted using the private key of the receiver 150 (shown in FIG. 1).

In some embodiments, the method further includes destroying the notarized original document upon an indication that an image of the notarized original document is received by the second imaging device, as depicted by reference numeral 620. In some embodiments, the notarized original document is destroyed after an indication that an image of the notarized original document was produced by the second imaging device. Electronically transmitting the original document 614 includes, in some embodiments, transmitting a unique machine identifier, such as a machine address code (MAC). In some instances, a time stamp, is also transmitted with the notarized original document. In another embodiment, the method also includes transmitting a global universal identifier with the notarized original document. When the time stamp and the MAC are transmitted with the image of the original document, the exact time sent and the machine used can also be verified.

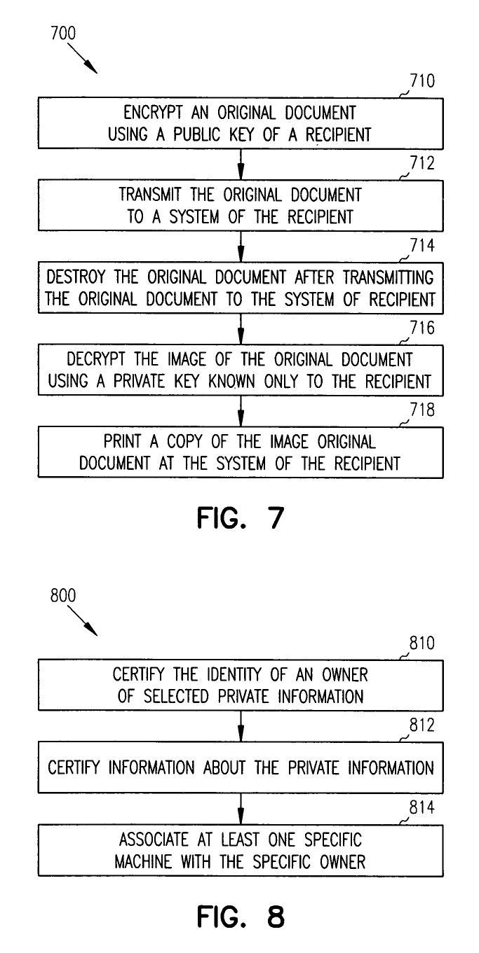

FIG. 7 is a flow chart of another method for transporting a document 700, according to an embodiment of this invention. The method of transporting a document 700 includes encrypting an original document using a public key of a recipient, as depicted by reference number 710, transmitting the original document to a system of the recipient, as depicted by reference number 712, destroying the original document after transmitting the original document to the system of recipient, as depicted by reference number 714, decrypting the image of the original document using a private key known only to the recipient, as depicted by reference number 716, and printing a copy of the image original document at the system of the recipient, as depicted by reference number 718. In some embodiments, the method further includes assuring that the system of the recipient is enabled to receive a transmission. In other embodiments, the method further includes assuring that the computing device of the recipient received the transmission before destroying the original document. In further embodiments, the method includes placing the received transmission in a storage device of the system of the recipient. The public key of the sender is used by the recipient to access the image of the original document in the storage device. In some embodiments, the method includes adding a global universal identification to the encrypted original document. The global universal identification includes a time component and a unique machine identifier. The unique machine identifier is a machine address code (MAC). The method further includes notarizing the original document. The image produced is again notarized after printing a copy of the image of the original document at the system of the recipient.

FIG. 8 is a flow chart of a security process 800, according to an embodiment of this invention. The security process 800 is generally used by any party that issues certificates, public keys and private keys to the users 140 and 150 of the document transport system 100 (see FIG. 1). The security process includes certifying the identity of an owner of selected private information, as depicted by reference number 810, certifying information about the private information, as depicted by reference number 812, and associating at least one specific machine with the specific owner, as depicted by reference number 814. Associating at least one specific machine with the specific owner 814 includes recording an address unique to the at least one machine and in some instances, recording a time stamp associating a time with a transaction. Associating at least one specific machine with the specific owner 814 includes verifying a media access control address unique to the at least one machine. In some embodiments, a unique identifier is added to the transmission by the sender. In some embodiments, the unique identifier is a global universal identifier. In some embodiments, the private information is a private key of a private key/public key security system.

An imaging apparatus includes a processor 430 (FIG. 4), a storage device 435, and software in the form of executable instructions 498 operable on the processor to: encrypt an original document using a public key of a recipient, transmit the original document to a system of the recipient, destroy the original document after transmitting the original document to the system of recipient, decrypt the image of a copy of an original document using a public key of a person sending the document, and print a copy of the image original document at the system of the recipient. In some embodiments of imaging apparatus, the storage device 435 stores an image of the original document until an indication that the transmitted document is received. In other embodiments, the software in the form of executable instructions 498 is further operable on the processor 430 to poll an other imaging apparatus 112 (FIG. 1) to which the image of the original document is transmitted to determine if the other imaging device 112 is enabled to receive the transmission of the original document.

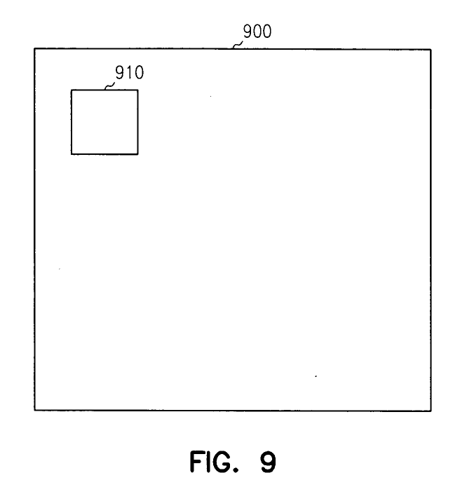

FIG. 9 is a block diagram of a computer readable medium 900 that includes an instruction set 910, thereon. The instruction set 910 can be any set of instructions including a computer program. The computer readable medium can be any computer-readable medium including a storage device or a signal-bearing medium. A computer-usable storage medium having a computer program thereon causes a suitably configured electronic device 400 to transport documents between a first imaging device and a second imaging device by performing the following when such program is executed on the information-handling system: encrypting an original document using a public key of a recipient, transmitting the original document from the first imaging device to the second imaging device, wherein the second imaging device is under control of the recipient, and destroying the original document after transmitting the original document to the second imaging device. In some embodiments, the computer-readable medium is further capable of performing the following when such program is executed on the information-handling system: decrypting the image of a copy of an original document using a public key of a person sending the document, and printing a copy of the image original document at the system of the recipient.

Although specific embodiments have been illustrated and described herein, those of ordinary skill in the art will appreciate that any arrangement calculated to achieve the same purpose can be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

In the foregoing Description of Embodiments of the Invention, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Description of Embodiments of the Invention, with each claim standing on its own as a separate preferred embodiment.

1. A method of transporting a document comprising:
encrypting an original document;
transmitting the original document to a system of the recipient;
destroying the original document after transmitting the original document to the system of recipient;
decrypting the image of the original document;
printing a copy of the image original document at the system of the recipient; and
certifying that the copy of the image was received from a sender.

2. The method of claim 1 further comprising assuring that the system of the recipient is enabled to receive a transmission.

3. The method of claim 1 further comprising assuring that the computing device of the recipient received the transmission before destroying the original document.

4. The method of claim 3 further comprising placing the received transmission in a storage device of the system of the recipient, wherein the public key of the sender is used by the recipient to access the image of the original document in the storage device.

5. The method of claim 1 further comprising adding a global universal identification to the encrypted original document.

6. The method of claim 5 wherein the global universal identification includes a time component and a unique machine identifier.

7. The method of claim 6 wherein the unique machine identifier is a machine address code (MAC).

8. The method of claim 1 further comprising notarizing the original document.

9. The method of claim 1 wherein certifying certifying that the copy of the image was received from a sender includes notarizing the document after printing a copy of the image of the original document at the system of the recipient.

10. The method of claim 1 wherein encrypting an original document further comprises use of a private key of the sender.

11. The method of claim 10 wherein encrypting an original document further comprises use of a public key of a recipient.

12. A security process comprising:
certifying the identity of an owner of selected private information;
certifying the private information; and
associating at least one specific machine with the specific owner.

13. The security process of claim 12 wherein associating at least one specific machine with the specific owner includes recording an address unique to the at least one machine.

14. The security process of claim 12 wherein associating at least one specific machine with the specific owner includes recording an address unique to the at least one machine and wherein the method further includes recording a time stamp associating a time with a transaction.

15. The security process of claim 12 wherein associating at least one specific machine with the specific owner includes verifying a machine address code (MAC) unique to the at least one machine.

16. The security process of claim 12 wherein associating at least one specific machine with the specific owner includes adding a unique identifier to transmissions by the sender.

17. The security process of claim 16 wherein the unique identifier is a global universal identifier.

18. The security process of claim 12 wherein certifying the private information includes certifying a private key of a private key/public key security system.

19. An imaging apparatus comprising:
a processor;
a storage device; and
software operable on the processor to:
encrypt an original document;
transmit the original document to a recipient; and
destroy the original document after transmitting the original document to recipient.

20. The imaging apparatus of claim 19 wherein the software is further operable on the processor to decrypt the image of a copy of an original document using a public key of a person sending the document.

21. The imaging apparatus of claim 19 wherein the storage device stores an image of the original, transmitted document until an indication that the transmitted document is received.

22. The imaging apparatus of claim 19 wherein the software is further operable on the processor to poll an other imaging apparatus to which the image of the original document is transmitted to determine if the other imaging device is enabled to receive the transmission of the original document.

23. A method for transporting a document comprising:
notarizing an original document;
electronically imaging the original document with a first imaging device;
electronically transmitting the original document from the first imaging device to a second imaging device;
electronically receiving an image of the original document at the second imaging device; and
notarizing the copy of the original document produced at the second imaging device from the image received at the second imaging device.

24. The method for transporting a document of claim 23 wherein electronically transmitting the original document and receiving the image of the original document at the second imaging device is done in a secure environment.

25. The method for transporting a document of claim 23 wherein electronically transmitting the original document further includes encrypting the image of the original document and decrypting the image of the original document at the second imaging device.

26. The method for transporting a document of claim 25 wherein notarizing an original document further includes certifying that the original document was imaged on the first imaging device.

27. The method for transporting a document of claim 25 wherein notarizing the copy of the original document produced at the second imaging device from the image received at the second imaging device further includes certifying that the copy of the original document was decrypted using the public key of the sender.

28. The method for transporting a document of claim 25 further comprising destroying the original document upon an indication that an image of the original document is received by the second imaging device.

29. The method for transporting a document of claim 25 further comprising destroying the original document upon an indication that an image of the notarized original document was produced by the second imaging device.

30. The method for transporting a document of claim 25 further comprising including transmitting a unique machine identifier with the notarized original document.

31. The method for transporting a document of claim 25 further comprising including transmitting a unique machine identifier and a time stamp with the notarized original document.

32. The method for transporting a document of claim 25 further comprising including transmitting a global universal identifier with the original document.

33. A computer-readable medium having a program available thereon for causing a suitably programmed information-handling system to transport documents between a first imaging device and a second imaging device by performing the following when such program is executed on the information-handling system:
encrypting an original document;
transmitting the original document from the first imaging device to the second imaging device, wherein the second imaging device is under control of the recipient;
transmitting an acknowledgment of receipt of an image of the original document from the second imaging device; and
destroying the original document at the first imaging device in response to receiving the acknowledgment from the second imaging device.

34. The computer-readable medium of claim 33 having a program further capable of performing the following when such program is executed on the information-handling system:
decrypting the image of a copy of an original document using a public key of a person sending the document; and
printing a copy of the image original document at the system of the recipient.

35. An apparatus for transporting a document comprising:
means for encrypting an original document;
means for transmitting the original document to a system of the recipient;
means for destroying the original document after transmitting the original document to the system of recipient;
means for decrypting the image of the original document; and
means for printing a copy of the image original document at the system of the recipient.

36. The apparatus of claim 35 further comprising means for assuring that the system of the recipient is enabled to receive a transmission.

37. The apparatus of claim 35 further comprising means for assuring that the computing device of the recipient received the transmission before destroying the original document.

38. The apparatus of claim 35 further comprising means for certifying that the copy of the image was received from a sender.

39. The apparatus of claim 35 further comprising means for identifying the encrypted original document.
